(19) United States
(12) Patent Application Publication
(10) Pub. No.: US 2016/0263731 A1
(43) Pub. Date: Sep. 15, 2016

(54) ROTARY IMPACT TOOL

(71) Applicant: Panasonic Intellectual Property Management Co., Ltd., Osaka (JP)

(72) Inventors: Hiroshi MATSUMOTO, Mie (JP); Takechika ISHIBASHI, Shiga (JP)

(21) Appl. No.: 15/061,424

(22) Filed: Mar. 4, 2016

(30) Foreign Application Priority Data
Mar. 10, 2015 (JP) 2015-047243

(51) Int. Cl. B25B 21/02

(52) U.S. Cl. CPC B25B 21/02

(57) ABSTRACT

A rotary impact tool includes an anvil that receives rotational impact force from a hammer of an impact mechanism. A driver cover covers the impact mechanism. A bearing is press fitted into and fixed to the driver cover to hold the anvil. A bearing separation restricting component restricts separation of the bearing from the driver cover. The bearing separation restricting component is hidden inside the driver cover and is invisible from an outer surface of the driver cover.

### CROSS-REFERENCE TO RELATED APPLICATIONS

This application is based upon and claims the benefit of priority from prior Japanese Patent Application No. 2015-047243, filed on Mar. 10, 2015, the entire contents of which are incorporated herein by reference.

### FIELD

The present invention relates to a rotary impact tool and, more particularly, to a bearing that holds an anvil of a rotary impact tool.

### BACKGROUND

Japanese Laid-Open Patent Publication No. 2010-76022, the entire contents of which are incorporated herein by reference, discloses a prior art rotary impact tool. The rotary impact tool includes an anvil that is held by a bearing. The bearing is press fitted into and fixed to a driver cover, which covers an impact mechanism that includes a hammer, which strikes the anvil. The impact mechanism coverts the rotational output of an electric motor to rotational impact force that rotates an output shaft. The rotary impact tool tightens or loosens a fastener with a bit coupled to the output shaft, such as a Phillips screwdriver bit.

### SUMMARY

The anvil is rotationally supported by a bearing which is press fitted into and fixed to the driver cover. Vibration produced when the hammer strikes the anvil may separate the bearing from the driver cover. Separation of the bearing from the driver cover results in the loss of a clearance that rotates the anvil and the hammer in a lubricative manner. This impedes lubricative rotation of the anvil and the hammer.

In a referential example shown in FIG. 5, a linear pin 94 is used to restrict separation of a bearing 93. More specifically, a driver cover 91 includes a pin hole 92 that is orthogonal to a rotary axis. The pin hole 92 extends from the outer surface of the driver cover 91 to the inner surface (wall surface of cylindrical bore) of the driver cover 91. The outer circumferential surface of the bearing 93 includes a socket 95, which receives the pin 94. When assembling the rotary impact tool, the bearing 93 is press fitted into the driver cover 91 along the rotary axis. Then, the pin 94 is inserted into the pin hole 92 from the outer side of the driver cover 91. The distal end of the pin 94 is press fitted into the socket 95 of the bearing 93. The pin 94 restricts separation of the bearing 93 from the driver cover 91. Finally, the driver cover 91 is covered with a protector 96 to hide the head of the pin 94. If the head of the pin 94 were visible from the driver cover 91, this would deteriorate the outer appearance of the rotary impact tool. The protector 96 improves the design of the rotary impact tool and hides the pin 94. However, the protector 96 increases the number of components.

It is an object of the present invention to provide a rotary impact tool that restricts separation of the bearing and improves the design without increasing the number of components.

One aspect of the present invention is a rotary impact tool including an anvil, a bearing, a driver cover, and a bearing separation restricting component. The anvil receives rotational impact force from a hammer of an impact mechanism. The bearing holds the anvil. The driver cover covers the impact mechanism. The bearing is press fitted into and fixed to the driver cover. The bearing separation restricting component is configured to restrict separation of the bearing from the driver cover. The bearing separation restricting component is hidden inside the driver cover and is invisible from an outer surface of the driver cover.

The present invention provides a rotary impact tool that restricts separation of the bearing and improves the design without increasing the number of components.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram of a rotary impact tool;

FIG. 2 is a cross-sectional view of an anvil holding structure;

FIG. 3 is a cross-sectional view of a bearing separation restricting structure;

FIG. 4 is a cross-sectional view illustrating how separation of the bearing is restricted; and

FIG. 5 is a cross-sectional view illustrating a bearing separation restricting structure for a rotary impact tool of a referential example.

### DETAILED DESCRIPTION OF THE EMBODIMENTS

One embodiment of a rotary impact tool will now be described.

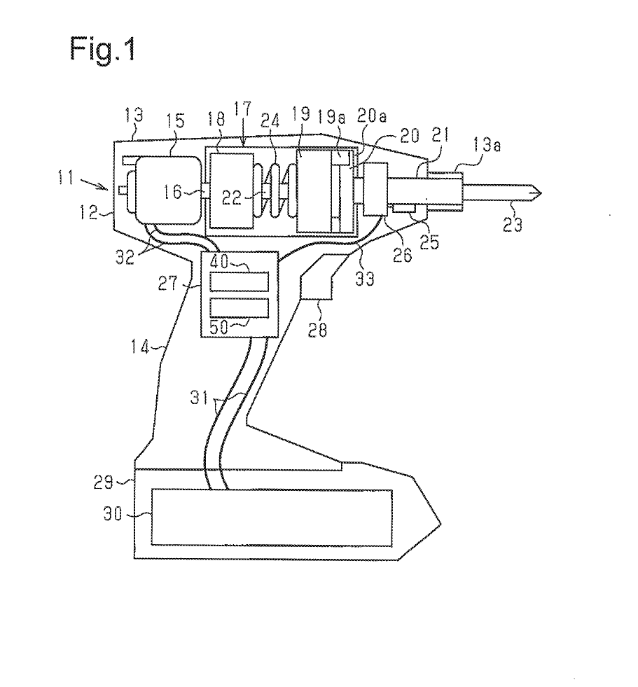

Referring to FIG. 1, a rotary impact tool 11 is a portable power tool that can be held with a single hand. The rotary impact tool 11 is used as, for example, an impact driver or an impact wrench. The rotary impact tool 11 includes a housing 12, which serves as an outer shell. The housing 12 includes a barrel 13 and a grip 14, which extends downward from the barrel 13. A trigger lever 28 is supported by the grip 14.

The barrel 13 accommodates a motor 15, which serves as a rotational drive source. The motor 15 includes an output shaft 16 that extends toward the distal end (right end as viewed in FIG. 1) of the barrel 13. The motor 15 is a DC motor such as a brush motor or a brushless motor. An impact mechanism 17 is coupled to the output shaft 16 of the motor 15.

In a low-load state, the impact mechanism 17 reduces the speed of the rotation produced by the motor 15 and generates a high-torque rotational output. In a high-load state, the impact mechanism 17 generates rotational impact force from the rotation produced by the motor 15. In the illustrated example, the impact mechanism 17 includes a reduction mechanism 18, a hammer 19, an anvil 20, and an output shaft 21. The reduction mechanism 18 reduces the rotation speed of the motor 15 by a predetermined reduction ratio. The rotation of which the speed is reduced and the torque is increased by the reduction mechanism 18 is transmitted to the hammer 19. The hammer 19 strikes the anvil 20. The striking of the anvil 20 rotates the output shaft 21. The output shaft 21 and the anvil 20 may be integrated into a single component. Alternatively, the output shaft 21 may be a component that is separate from and coupled to the anvil 20.

The hammer 19 is rotatable relative to a drive shaft 22, which is rotated by the reduction mechanism 18, and movable along the drive shaft 22. A coil spring 24 is arranged between the reduction mechanism 18 and the hammer 19. The coil spring 24 urges the hammer 19 toward the anvil 20. The hammer 19 is normally in contact with the anvil 20 in the axial direction due to the elastic force of the coil spring 24. The hammer 19 includes hammer heads 19a, which abuts against radially outer portions of the anvil 20 that define anvil claws 20a when the hammer 19 rotates. The rotation of the drive shaft 22, the speed of which has been reduced by the reduction mechanism 18, causes the hammer heads 19a to abut against the anvil claws 20a in the circumferential direction and rotate the anvil 20 integrally with the hammer 19. This rotates the output shaft 21.

A chuck 13a projects from the distal end (right end as viewed in FIG. 1) of the barrel 13. A bit 23 is attached to the chuck 13a. The chuck 13a, which is rotated integrally with the output shaft 21, rotates the bit 23. The load applied to the output shaft 21 increases as the bit 23 tightens a fastener, such as a bolt (not shown), and when the bit 23 loosens a fastener. When a predetermined amount of force or greater acts between the hammer 19 and the anvil 20, the hammer 19 compresses the coil spring 24 and moves rearward (leftward as viewed in FIG. 1) along the drive shaft 22. When the hammer heads 19a of the hammer 19 are disengaged from the anvil claws 20a of the anvil 20, the hammer 19 rotates freely. As the hammer 19 rotates freely, the urging force of the coil spring 24 returns the hammer 19 to the position where the hammer 19 is engageable again with the anvil 20. As a result, the hammer 19 strikes the anvil 20. The output shaft 21 receives a large load when the hammer 19 strikes the anvil 20. The load is repetitively applied whenever the hammer 19 rotates freely relative to the anvil 20 against the urging force of the coil spring 24. In this manner, the rotary impact tool 11 tightens or loosens a fastener such as a bolt.

A torque sensor 25 is coupled to the output shaft 21 of the rotary impact tool 11. The torque sensor 25 may be a strain sensor that detects the strain of the output shaft 21. The torque sensor 25 detects the strain of the output shaft 21, which corresponds to the rotational impact force (impact torque) applied to the output shaft 21, and outputs a torque detection signal, which has a voltage corresponding to the strain. The torque detection signal is provided via a slip ring 26, which is arranged on the output shaft 21, to a control circuit 40, which controls the motor 15.

The control circuit 40 is arranged on, for example, a circuit board 27 in the grip 14. The circuit board 27 may include a drive circuit 50 that supplies the motor 15 with drive current under the control of the control circuit 40. A battery pack 29 is attached in a removable manner to the lower end of the grip 14.

The circuit board 27 is connected to a rechargeable battery 30 in the battery pack 29 by power lines 31, connected to the motor 15 by power lines 32, and connected to the torque sensor 25 (slip ring 26) by a signal line 33. Further, the circuit board 27 is connected to a trigger switch (not shown) that detects operation of the trigger lever 28.

A bearing 61 that holds the anvil 20 and a structure that restricts separation of the bearing 61 will now be described.

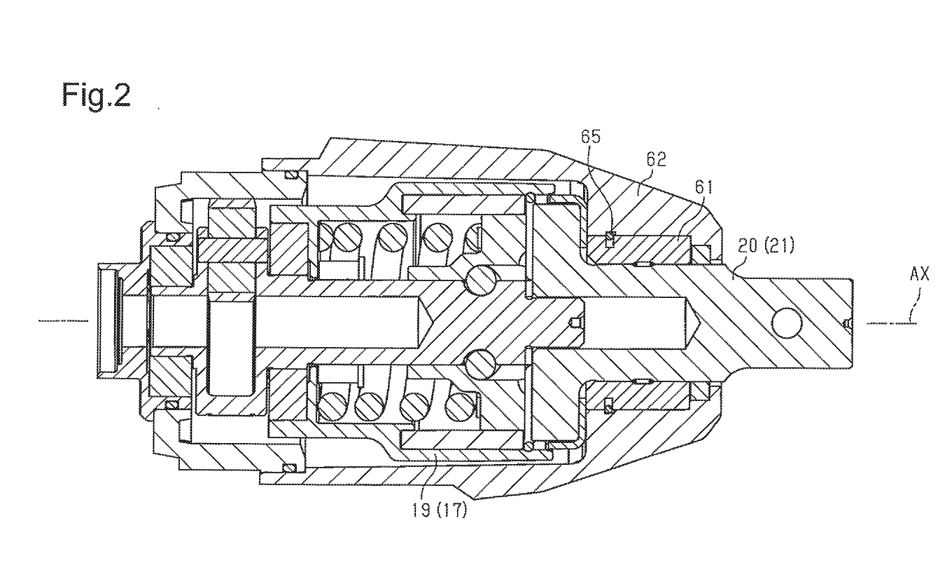

In the example shown in FIG. 2, the anvil 20 is a one-piece component integrated with the output shaft 21. The anvil 20 is supported in a rotatable manner by the bearing 61 near the distal end of the barrel 13 (refer to FIG. 1) of the housing 12. The bearing 61 is press fitted into and fixed to a driver cover 62, which forms the barrel 13. The driver cover 62 covers the impact mechanism 17 including the hammer 19. The driver cover 62 may be a one-piece member.

Referring to FIG. 2, the rotary impact tool 11 has a rotary axis AX. The anvil 20 rotates about the rotary axis AX. An elastic component, which may be a C-shaped spring 65, extends around the rotary axis AX.

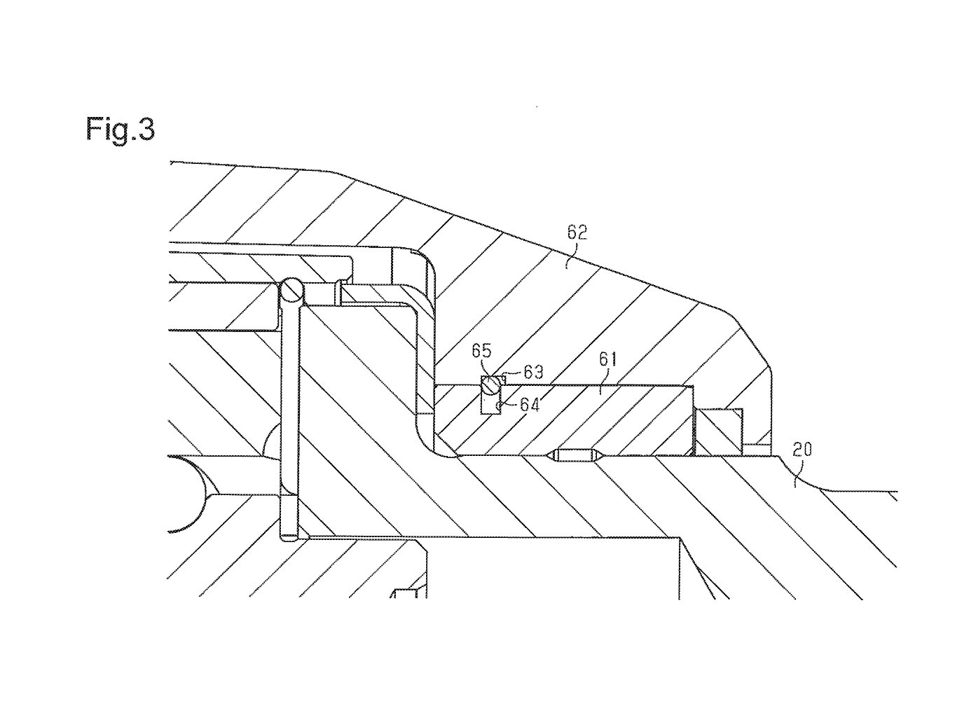

As shown in the enlarged view of FIG. 3, the driver cover 62 has an inner circumferential surface that is a wall surface of a cylindrical bore. The inner circumferential surface includes a first groove 63 that extends in the circumferential direction. The bearing 61 has an outer circumferential surface including a second groove 64 that extends in the circumferential direction. The first groove 63 cooperates with the second groove 64 to form a void that receives the C-shaped spring 65. The C-shaped spring 65 is arranged in the void in a slightly deformed state, or nearly non-deformed state, in which the interval between the two ends of the C-shaped spring 65 is narrowed. The elastic force that widens the interval between the two ends abuts the C-shaped spring 65 against the bottom surface of the first groove 63 and positions the driver cover 62. In this state, the C-shaped spring 65 occupies a portion of the second groove 64. More specifically, when cutting the C-shaped spring 65 along a plane orthogonal to the rotary axis AX, the outer half of the C-shaped spring 65 is located in the first groove 63, and the remaining inner half of the C-shaped spring 65 is located in the second groove 64.

The C-shaped spring 65 is used in a strongly deformed state and a lightly deformed state, which is a state between the strongly deformed state and a non-deformed state. For example, the C-shaped spring 65 is in the strongly deformed state just before the bearing 61 is completely press fitted into the driver cover 62, and the C-shaped spring 65 is in the lightly deformed state when the bearing 61 is completely press fitted into the driver cover 62. In the illustrated example, the C-shaped spring 65 is completely accommodated in the second groove 64 when in the strongly deformed state and accommodated in both of the first groove 63 and the second groove 64 when in the lightly deformed state. The outer portion of the C-shaped spring 65 presses the bottom surface of the first groove 63 outward in the radial direction. The inner portion of the C-shaped spring 65 is accommodated in the second groove 64. A gap extends between the inner portion of the C-shaped spring 65 and the bottom surface (deepest portion) of the second groove 64.

The bearing 61 is press fitted into the driver cover 62 as described below.

First, the bearing 61 is press fitted into the driver cover 62 with the C-shaped spring 65 accommodated in the second groove 64 of the bearing 61 in the strongly deformed state. When the second groove 64 is aligned with the first groove 63, the bearing 61 is completely press fitted into the driver cover 62. Simultaneously, the C-shaped spring 65 is released from the strongly deformed state in the void formed by the two grooves 63 and 64 and shifted to the lightly deformed state. This restricts separation of the bearing 61 from the two grooves 63 and 64. The first groove 63 of the driver cover 62 corresponds to a first recess or an outer recess, and the second groove 64 of the bearing 61 corresponds to a second recess or an inner recess. The C-shaped spring 65 corresponds to a bearing separation restricting component. The C-shaped spring 65 may be referred to as a non-linear or curved elastic component. The grooves 63 and 64 may each be a curved groove or an annular groove.

The operation of the rotary impact tool 11 will now be described.

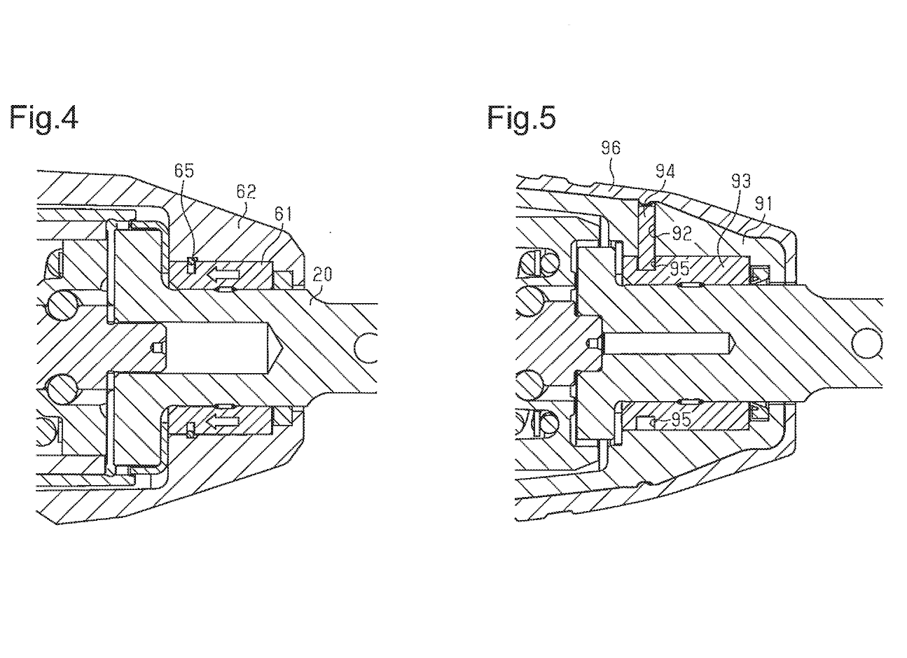

The motor 15 produces rotation when a user operates the trigger lever 28. The impact mechanism 17 converts the rotation of the motor 15 to a rotational impact force applied to the anvil 20 of the output shaft 21. The rotational impact force from the impact mechanism 17 rotates the output shaft 21 including the anvil 20. The rotational impact force generates vibration that may act to separate the bearing 61, which holds the anvil 20, from the driver cover 62 in the axial direction (leftward direction indicated by arrow in FIG. 4).

In the present example, however, the C-shaped spring 65, which is located between the bearing 61 and the driver cover 62, does not allow the bearing 61 to move in the axial direction. This restricts separation of the bearing 61 from the driver cover 62. As a result, a fastener such as a bolt may be tightened and loosened in a desirable manner with the anvil 20 appropriately held by the bearing 61.

The C-shaped spring 65 is hidden inside the driver cover 62 and is invisible from the outer surface of the driver cover 62. Thus, the present example does not use a protector to cover the driver cover 62.

The above embodiment has the advantages described below.

(1) The C-shaped spring 65 restricts separation of the driver cover 62 from the bearing 61. Further, the C-shaped spring 65 is hidden inside the driver cover 62 and is invisible from the outer surface of the driver cover, and there is no need for a protector. This allows for design improvements. Thus, separation of the bearing 61 is restricted and the design is improved without increasing the number of components.

(2) When arranging the C-shaped spring 65 in the void formed by the first groove 63 and the second groove 64, the first groove 63 positions the C-shaped spring 65. Further, the C-shaped spring 65 is arranged over the first groove 63 and the second groove 64. This restricts separation of the bearing 61.

(3) When the task for press fitting and fixing the bearing 61 to the driver cover 62 is completed, the C-shaped spring 65 is simultaneously shifted to the lightly deformed state, or nearly non-deformed state, to prevent separation of the bearing 61. This improves the coupling efficiency of the bearing 61.

(4) The bearing 61 is not shortened in the axial direction and has a sufficient length that obtains a wide area of contact with the anvil 20 and reduces friction of the bearing 61. This obtains the desired bearing performance.

(5) The bearing 61 is not longer than necessary. Thus, the driver cover 62 and, consequently, the barrel 13 do not increase the entire length of the rotary impact tool 11.

(6) Separation of the bearing 61 is limited while improving the design and obtaining the desired bearing performance without increasing the entire length of the rotary impact tool 11.

It should be apparent to those skilled in the art that the present invention may be embodied in many other specific forms without departing from the spirit or scope of the invention. Particularly, it should be understood that the present invention may be embodied in the following forms.

The depths of the first groove 63 and the second groove 64 may be adjusted so that the C-shaped spring 65 is completely accommodated in the first groove 63 in the strongly deformed state. In this case, when the bearing 61 is completely press fitted into the driver cover 62, the C-shaped spring 65 simultaneously shifts to a lightly deformed state and is accommodated in both of the first groove 63 and the second groove 64 to restrict separation of the bearing 61 from the driver cover 62.

When the bearing 61 is completely press fitted into the driver cover 62, it is preferred that the C-shaped spring 65 be simultaneously shifted to the lightly deformed state. Instead, the C-shaped spring 65 may be shifted to a non-deformed state. In this case, the depths of the first groove 63 and the second groove 64 are set to hold the C-shaped spring 65 at the desired position.

The first recess in the inner circumferential surface of the driver cover 62 is not limited to a single groove. The inner circumferential surface may include more than one groove arranged in the axial direction. Alternatively, a plurality of non-continuous recesses may be arranged in the rotational direction. In this case, the outer circumferential surface of the bearing 61 includes second recesses opposing the first recesses, and a bearing separation restricting component is arranged in each void formed by the opposing recesses.

It is preferred that the bearing separation restricting component be an elastic component such as the C-shaped spring 65 to facilitate coupling. However, a different bearing separation restricting component such as a snap ring may be used.

The structure of the rotary impact tool 11 may be changed as required.

The invention is not limited to the foregoing embodiments and various changes and modifications of its components may be made without departing from the scope of the present invention. Also, the components disclosed in the embodiments may be assembled in any combination for embodying the present invention. For example, some of the components may be omitted from all components disclosed in the embodiments. Further, components in different embodiments may be appropriately combined. The scope of the present invention and equivalence of the present invention are to be understood with reference to the appended claims.

1. A rotary impact tool comprising:
an anvil that receives rotational impact force from a hammer of an impact mechanism;
a bearing that holds the anvil;
a driver cover that covers the impact mechanism, wherein the bearing is press fitted into and fixed to the driver cover;
a bearing separation restricting component configured to restrict separation of the bearing from the driver cover, wherein the bearing separation restricting component is hidden inside the driver cover and is invisible from an outer surface of the driver cover.

2. The rotary impact tool according to claim 1, wherein
the driver cover has an inner circumferential surface including a first recess,
the bearing has an outer circumferential surface including a second recess,
the first recess cooperates with the second recess to form a void, and
the bearing separation restricting component includes an elastic component accommodated in the void.

3. The rotary impact tool according to claim 2, wherein the elastic component is accommodated in both of the first recess and the second recess.

4. The rotary impact tool according to claim 1, wherein
the driver cover has an inner circumferential surface that includes a first groove,
the bearing includes an outer circumferential surface that includes a second groove,
the first groove cooperates with the second groove to form a void, and
the bearing separation restricting component includes a C-shaped spring accommodated in the void.

5. The rotary impact tool according to claim 4, wherein
the C-shaped spring is elastically deformed and accommodated in one of the first groove and the second groove to allow the bearing to be press fitted into the driver cover, and
when the bearing is completely press fitted into the driver cover, the C-shaped spring is accommodated in both of the first groove and the second groove.

6. The rotary impact tool according to claim 5, wherein
when the bearing is completely press fitted into the driver cover, the C-shaped spring presses a deepest portion of one of the first groove and the second groove in a radial direction, and the C-shaped spring is separated from a deepest portion of the other one of the first groove and the second groove in the radial direction.

7. The rotary impact tool according to claim 1, wherein the driver cover includes an outer surface that serves as an outermost surface of the rotary impact tool.

8. A rotary impact tool comprising:
a rotary axis;
an anvil rotated about the rotary axis;
a bearing that supports the anvil in a rotatable manner;
a driver cover including a cylindrical bore configured to receive the bearing that is press fitted into the cylindrical bore; and
a curved elastic component engaged with an outer surface of the bearing and a bore wall surface of the cylindrical bore to restrict separation of the bearing from the driver cover,
wherein the bore wall surface of the cylindrical bore includes a first curved groove configured to accommodate an outer portion of the curved elastic component with the curved elastic component extending around the rotary axis.

9. The rotary impact tool according to claim 8, wherein the outer surface of the bearing includes a second curved groove configured to accommodate an inner portion of the curved elastic component with the curved elastic component extending around the rotary axis.

10. The rotary impact tool according to claim 9, wherein when the bearing is completely press fitted into the cylindrical bore, the curved elastic component presses a deepest portion of one of the first curved groove of the bore wall surface and the second curved groove of the bearing in a radial direction, and the curved elastic component is separated from a deepest portion of the other one of the first curved groove of the bore wall surface and the second curved groove of the bearing in the radial direction.
